(19) United States
(12) Patent Application Publication
(10) Pub. No.: US 2026/0189124 A1
(43) Pub. Date: Jul. 2, 2026

(54) AUTOMATIC PASS-THROUGH MODE ENTRY AND EXIT FOR POWER CONVERSION CIRCUIT

(71) Applicant: Renesas Electronics America Inc., Milpitas, CA (US)

(72) Inventors: Heonyoung KIM, Cary, NC (US); Sungkeun LIM, Apex, NC (US); Yen-Mo CHEN, Morrisville, NC (US)

(73) Assignee: Renesas Electronics America Inc., Milpitas, CA (US)

(21) Appl. No.: 19/001,728

(22) Filed: Dec. 26, 2024

(51) Int. Cl. H02M 1/00; H02M 1/32; H02M 3/158

(52) U.S. Cl. CPC H02M 1/0032; H02M 3/158; H02M 1/32

(57) ABSTRACT

Systems and methods for implementing pass-through mode (PTM) of a power conversion circuit are described. The system can include a first stage controller and a first stage. The first stage controller is configured to monitor an input voltage and generate a PTM control signal based on the input voltage to control an operation of. The first stage is connected to the first stage controller. The first stage can include the power conversion circuit configured to convert the input voltage to a converter output voltage.

### BACKGROUND

The present disclosure relates in general to systems and methods for implementing automatic pass-through mode (PTM) entry and exit for a power conversion circuit, particularly, to the implementation of automatic PDM entry and exit using an input voltage digitally configurable reference (VinDAC).

In recent years, the power capacity in Universal Serial Bus Power Delivery (USB PD) applications has significantly increased. The USB PD standard now supports output levels up to 48V and 5A, enabling power delivery of up to 240 W. This advancement allows USB PD to meet the demands of high-power devices more effectively. Traditionally, buck-boost converters have been employed to manage power delivery in these applications.

### SUMMARY

In an aspect, a system for implementing PTM of a power conversion circuit is generally described. The system can include a first stage controller and a first stage. The first stage controller is configured to monitor an input voltage and generate a PTM control signal based on the input voltage to control an operation of the first stage. The first stage can include the power conversion circuit configured to convert the input voltage to a converter output voltage.

In an aspect, an integrated circuit for implementing the PTM of a power conversion circuit is generally described. The integrated circuit can include a first stage controller and a first stage. The first stage controller is configured to monitor an input voltage. The first stage is connected to the first stage controller. The first stage can include the power conversion circuit configured to convert the input voltage to a converter output voltage. The first stage controller is further configured to generate a PTM control signal indicating the entry or exit of the PTM of the power conversion circuit based on an input voltage digitally configurable reference.

In an aspect, a method for implementing the PTM of a power conversion circuit is generally described. The method can include receiving a control bit. The method can further include determining whether the control bit is valid. The method can further include determining whether an input voltage is lower than an input voltage digitally configurable reference upon determining that the control bit is valid. The method can further include providing a PTM control signal indicating entry of the PTM of the power conversion circuit upon determining that the input voltage is lower than the input voltage digitally configurable reference.

Further features as well as the structure and operation of various embodiments are described in detail below with reference to the accompanying drawings. In the drawings, reference numbers indicate identical or functionally similar elements.

### BRIEF DESCRIPTION OF THE DRAWINGS

FIG. 1 is a diagram showing an example system for implementing automatic PTM entry and exit based on an input voltage digitally configurable reference VinDAC according to an illustrative embodiment.

FIG. 2 is a diagram showing an example power conversion circuit implementing automatic PTM entry and exit based on an input voltage digitally configurable reference VinDAC according to an illustrative embodiment.

FIG. 3A shows timing diagrams of the three-level buck converter working in the low voltage range switching pattern according to an illustrative embodiment.

FIG. 3B shows timing diagrams of the three-level buck converter working in the high voltage range switching pattern according to an illustrative embodiment.

FIG. 4A is a diagram showing the example three-level buck converter working in PTM according to an illustrative embodiment.

FIG. 4B shows timing diagrams of the three-level buck converter working in PTM according to an illustrative embodiment.

FIG. 5 is a diagram showing an example PDC for implementing automatic PTM entry and exit based on an input voltage digitally configurable reference VinDAC according to an illustrative embodiment.

FIG. 6 illustrates a process that implements automatic PTM entry and exit based on an input voltage digitally configurable reference VinDAC according to an illustrative embodiment.

FIG. 7 shows example simulation results of the system 100 for implementing automatic PTM entry and exit based on an input voltage digitally configurable reference VinDAC according to an illustrative embodiment.

### DETAILED DESCRIPTION

In the following description, numerous specific details are set forth, such as particular structures, components, materials, dimensions, processing steps, and techniques, in order to provide an understanding of the various embodiments of the present application. However, it will be appreciated by one of the ordinary skills in art that the various embodiments of the present application may be practiced without these specific details. In other instances, conventional structures or processing steps have not been described in detail in order to avoid obscuring the present application.

The demand for higher power levels in Universal Serial Bus Power Delivery (USB PD) applications has increased in recent years, with the USB PD standard now supporting a power output of up to 48V at 5 A, allowing for a power level of 240 W. However, this power increase poses several challenges for conventional power converter architectures. Traditional single-stage buck-boost converters are not well-suited to manage the high thermal stresses that arise at this power level, as they are unable to sufficiently dissipate the thermal losses generated, leading to inefficiencies and potential overheating issues.

To address the limitations of the conventional single-stage buck-boost converters, a two-stage power conversion approach is used. In this two-stage system, the first stage utilizes a power conversion circuit such as a three-level buck converter. This topology switches between the input voltage Vin and half the input voltage Vin/2, or between half the input voltage Vin/2 and the ground, significantly reducing the inductor ripple and stress on the switching devices. Compared to the converter which switches between the full input voltage Vin and ground, the ripple and stress can be significantly reduced, allowing for improved efficiency and enhanced reliability in high-power applications.

The second stage of the system follows the first stage three-level buck converter and further stabilizes the output. The second stage can include a Narrow Voltage Direct Charging (NVDC) or a Hybrid Power Buck-Boost (HPBB) converter, as used in conventional circuits. In this two-stage configuration, the first-stage three-level buck converter steps down the voltage, while the second stage further regulates and stabilizes the output voltage. This architecture is beneficial as the two-stage setup distributes thermal and electrical stress, reducing energy losses that would occur with a single-stage converter.

Additionally, this disclosure incorporates an automatic PTM control mechanism, which improves the entry and exit from PTM based on input voltage levels. The PTM can be triggered by a PTM control signal generated based on a comparison result of the input voltage and the input voltage digitally configurable reference VinDAC which is configurable. When the input voltage drops below the input voltage digitally configurable reference VinDAC, the three-level buck converter can transition to PTM, shorting the input voltage to the output through specific switching devices. The PTM mode is advantageous in low input voltage scenarios, such as when a 5V USB input is used, as the PTM mode reduces inductor losses and switching losses by maintaining the phase node switching at a reduced frequency. Moreover, a configurable control bit can be used to control the automatic PTM activation based on input voltage conditions without impacting other control loops in the system, such as the input voltage (Vin) loop, the constant voltage (CV) loop, the charging current (CC) loop, or the output current limit (CL) loop. As an example, the charging current CC loop can be used in battery charger like the second stage 130.

The control scheme and two-stage power conversion configuration collectively offer an efficient, thermally stable, and adaptable solution for high-power USB PD applications, addressing the challenges posed by increased power demands and providing improved flexibility in power conversion circuits. Furthermore, by incorporating digitally configurable PTM entry and exit thresholds, this disclosure achieves improved efficiency in low-power scenarios, such as 5V USB-C applications.

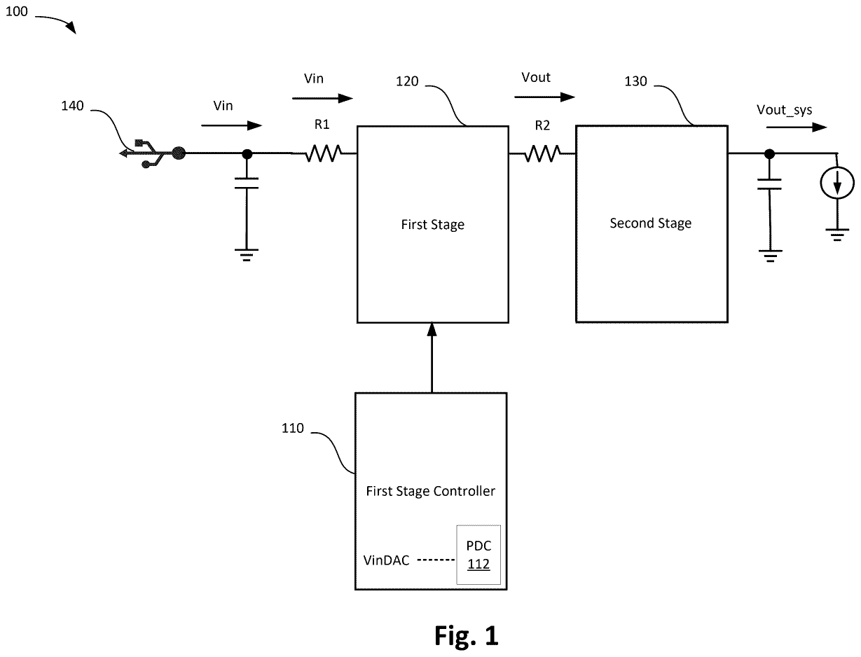

FIG. 1 is a diagram showing an example system 100 for implementing automatic PTM entry and exit based on an input voltage digitally configurable reference VinDAC according to an illustrative embodiment. For instance, system 100 can process power up to 48V/5A, totaling 240 W. In this example, the system 100 can include a first stage controller 110, a first stage 120, and a second stage 130.

The first stage controller 110 can monitor the input voltage Vin from a USB connector 140 and generate a control signal for controlling the operation of the first stage 120. For instance, the first stage controller 110 can activate the PTM of the power conversion circuit in the first stage 120 when the input voltage Vin falls below the configurable input voltage digitally configurable reference VinDAC.

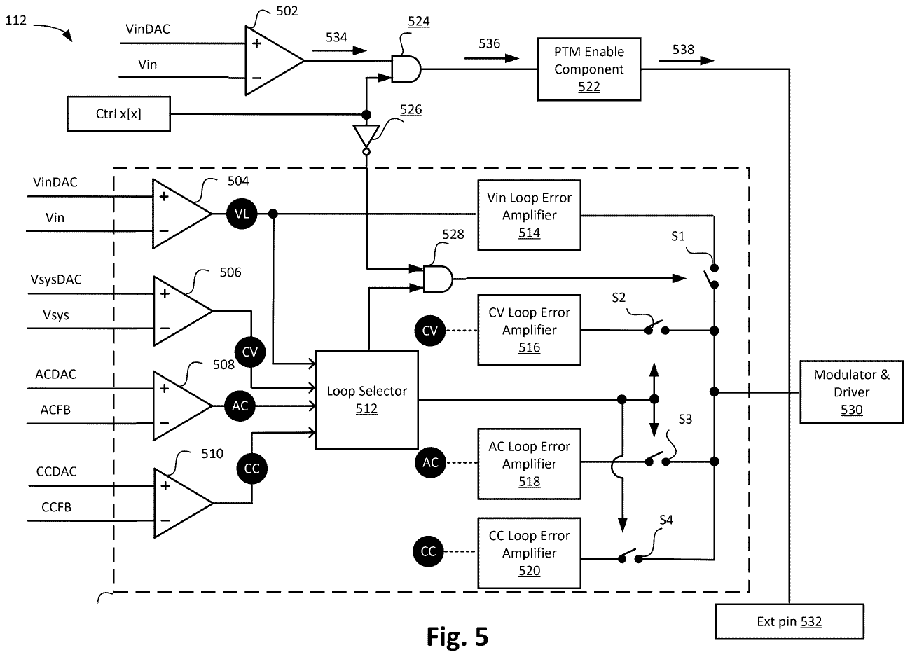

The first stage controller 110 can include a power delivery controller (PDC) 112 which is configured to manage the control loops—input voltage (Vin) loop, constant voltage (CV) loop, charging current (CC) loop, and output current limit (CL) loop—to keep the proper operation of the power conversion circuit in the first stage 120. The Vin loop) is a control mechanism that regulates the power conversion circuit based on the input voltage. The CV loop is a feedback control mechanism that maintains a constant output voltage of the buck converter, regardless of changes in load or input voltage. The CC loop is a can be used in battery charger like the second stage. For instance, the CC loop can be an output current limit loop in a voltage regulator, or a charging current loop in a battery charger. The CL loop is a mechanism that limits the input current from exceeding an overcurrent threshold, protecting both the converter and the load from potential damage due to overcurrent conditions. Additional details of PDC 112 are provided throughout this disclosure such as descriptions with respect to FIGS. 5-7.

The first stage 120 is connected to the output of the first stage controller 110 via a first resister R1. The first stage 120 can receive the input voltage Vin from the first stage controller 110 and output a converter output voltage Vout.

The first stage 120 can be a voltage regulator which includes a power conversion circuit such as a three-level buck converter. The three-level buck converter can work in a low voltage range switching pattern and a high voltage range switching pattern. In the low voltage range switching pattern, the output voltage is less than half of the input voltage, i.e., Vout<Vin/2. In the high voltage range switching pattern, the output voltage is greater than half of the input voltage and less than the input voltage, i.e., Vin/2<Vout<Vin.

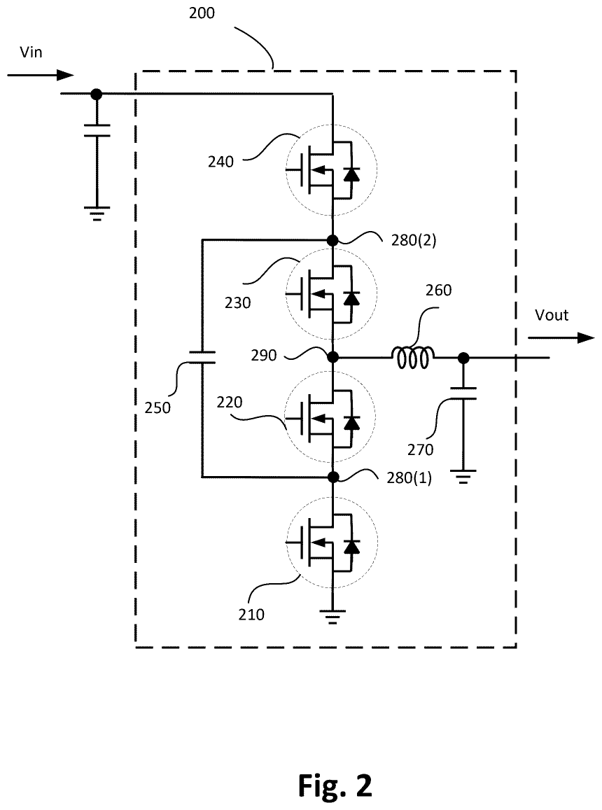

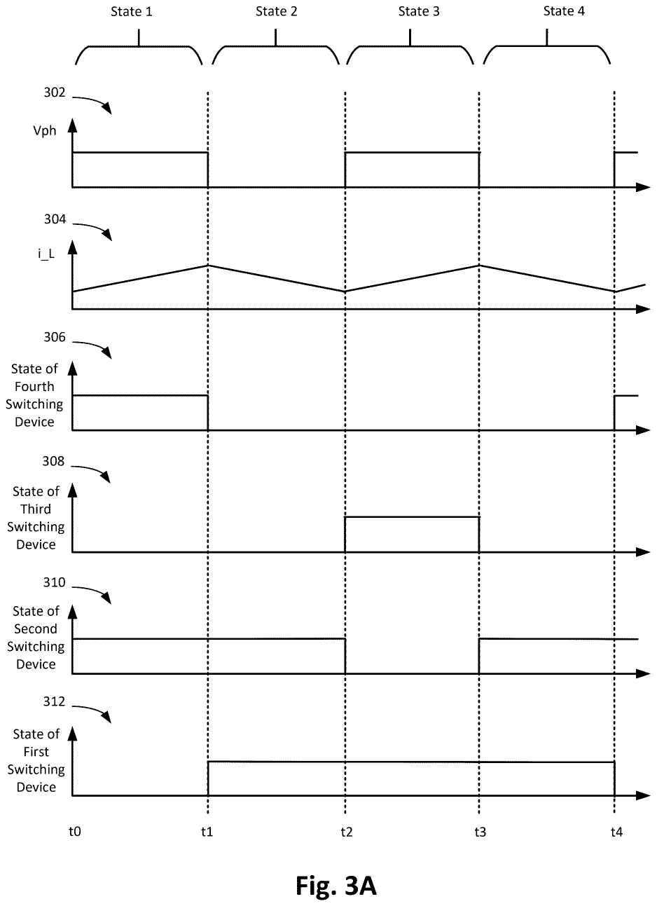

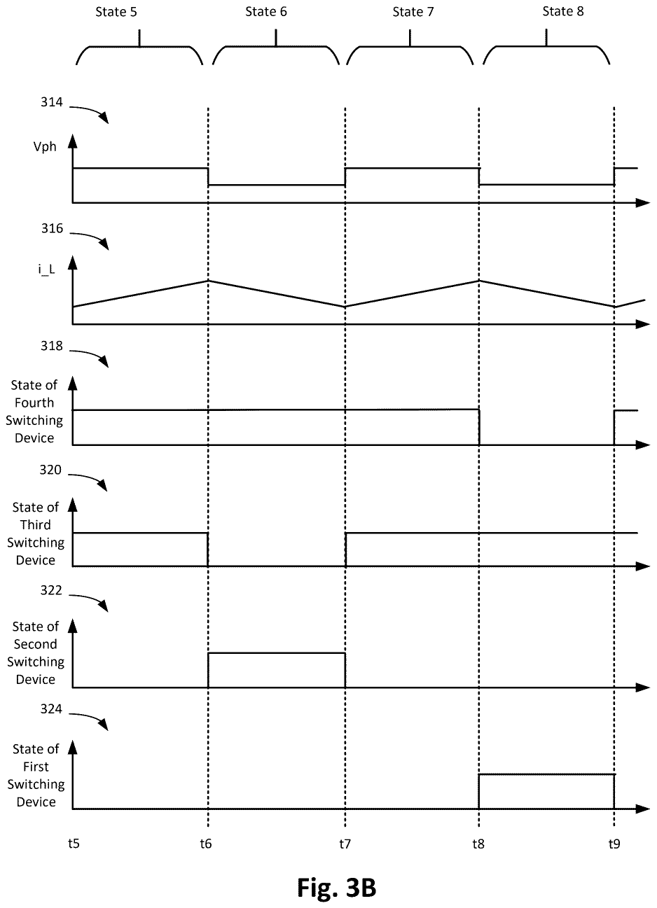

Additionally, the power conversion circuit (i.e., the three-level buck converter) can enter and exit the PTM mode. The PTM mode bypasses the regular power conversion process, enabling direct input-to-output power transfer to improve efficiency at a low input voltage. Additional details of the power conversion circuit (i.e., the three-level buck converter) are provided throughout this disclosure such as descriptions with respect to FIGS. 2, 3A, and 3B.

The second stage 130 is connected to the output of the first stage 120 via a second resistor R2. The second stage 130 receives the converter output voltage Vout from the first stage 120. The second stage 130 can include an NVDC or an HPBB converter, as used in conventional circuits, to further stabilize and regulate the converter output voltage Vout provided by the power conversion circuit of the first stage 120. The second stage 130 can provide the system output voltage Vsys.

FIG. 2 is a diagram showing an example power conversion circuit implementing automatic PTM entry and exit based on an input voltage digitally configurable reference VinDAC according to an illustrative embodiment. For instance, the power conversion circuit can be a three-level buck converter 200 that can be used in the first stage 120 in FIG. 1. The three-level buck converter 200 can be used to regulate the output voltage by stepping down the input voltage Vin in a controlled manner. The three-level buck converter 200 can be configured to achieve three distinct voltage levels, i.e., the input voltage, the ground, and a midpoint (i.e., half of the input voltage).

Referring to FIG. 2, the three-level buck converter 200 can include a first switching device 210, a second switching device 220, a third switching device 230, a fourth switching device 240, a flying capacitor 250, an inductor 260, and an output capacitor 270. As an example, the first switching device 210, the second switching device 220, the third switching device 230, and the fourth switching device 240 can be implemented with metal-oxide-semiconductor field-effect transistors (MOSFETs). Note that other types of switching devices can be used.

The first switching device 210 and the second switching device 220 are connected in series between the ground and the inductor 260. The first switching device 210 and the second switching device 220 are connected to each other at a first node 208(1).

The third switching device 230 and the fourth switching device 240 are connected in series between the input voltage Vin and the inductor 260. The third switching device 230 and the fourth switching device 240 are connected at a second node 280(2). The second switching device 220 and the third switching device 230 are connected at a phase node 290.

The flying capacitor 250 is connected between the first node 280(1) and the second node 280(2). The flying capacitor 250 is configured to bypass the second switching device 220 or the third switching device 230 during the switching operation of the three-level buck converter 200.

The inductor 260 is connected between the phase node 290 and the converter output voltage Vout. The inductor 260 is configured to smooth out the current supplied to the load.

The output capacitor 270 is connected between the inductor 260 and the ground. The output capacitor 270 is configured to smooth out voltage pulses caused by the switching action of the converter, reducing the ripple of the converter output voltage Vout.

FIG. 3A and FIG. 3B are diagrams showing the switching patterns of the three-level buck converter 200 when the three-level buck converter 200 is not working in PTM according to an illustrative embodiment. As described above, the three-level buck converter 200 can work in the low voltage range switching pattern and the high voltage range switching pattern.

FIG. 3A shows timing diagrams of the three-level buck converter 200 working in the low voltage range switching pattern according to an illustrative embodiment. As described above, in the low voltage range switching pattern, the converter output voltage Vout is less than half of the input voltage Vin, i.e., Vout<Vin/2.

Referring to FIG. 3A, diagram 302 shows the phase node voltage Vph over time, wherein the vertical axis represents the phase node voltage Vph, and the horizontal axis represents time. Diagram 304 shows the inductor current i_L over time, wherein the vertical axis represents the inductor current i_L, and the horizontal axis represents time. Diagram 306 shows the on/off state of the fourth switching device 240 over time. Diagram 308 shows the on/off state of the third switching device 230 over time. Diagram 310 shows the on/off state of the second switching device 220. Diagram 312 shows the on/off state of the first switching device 210 over time.

In the low voltage range switching pattern, the three-level buck converter 200 can have four states, i.e., state 1, state 2, state 3, and state 4. In state 1, between the time point to and the time point t1, the first switching device 210 and the third switching device 230 are in the off state, while the second switching device 220 and the fourth switching device 240 are in the on state. The inductor current i_L increases linearly. The phase node voltage Vph equals to half of the input voltage Vin, and can be represented in the following equation (1).

$$Vph = Vin - Vfly = Vin / 2 \qquad ( 1 )$$

In the above equation (1), Vph represents the phase node voltage. Vin represents the input voltage Vin. Vfly represents the voltage across the flying capacitor 250.

In state 2, between the time point t1 and the time point t2, the first switching device 210 and the second switching device 220 are in the on state, while the third switching device 230 and the fourth switching device 240 are in the off state. The inductor current i_L decreases linearly. The phase node voltage Vph is 0 volt.

In state 3, between the time point t2 and the time point t3, the first switching device 210 and the third switching device 230 are in the on state, while the second switching device 220 and the fourth switching device 240 are in the off state. The inductor current i_L increases linearly. The phase node voltage Vph equals to half of the input voltage Vin and can be represented by the above equation (1).

In state 4, between the time point t3 and the time point t4, the first switching device 210 and the second switching device 220 are in the on state, while the third switching device 230 and the fourth switching device 240 are in the off state. The inductor current i_L decreases linearly. The phase node voltage Vph is 0 volt.

FIG. 3B shows timing diagrams of the three-level buck converter 200 working in the high voltage range switching pattern according to an illustrative embodiment. As described above, in the high voltage range switching pattern, the converter output voltage Vout is greater than half of the input voltage Vin and less than the input voltage Vin, i.e., Vin/2<Vout<Vin.

Referring to FIG. 3B, diagram 314 shows the phase node voltage Vph over time, wherein the vertical axis represents the phase node voltage Vph, and the horizontal axis represents time. Diagram 316 shows the inductor current i_L over time, wherein the vertical axis represents the inductor current i_L, and the horizontal axis represents time. Diagram 318 shows the on/off state of the fourth switching device 240 over time. Diagram 320 shows the on/off state of the third switching device 230 over time. Diagram 322 shows the on/off state of the second switching device 220. Diagram 324 shows the on/off state of the first switching device 210 over time.

In the high voltage range switching pattern, the three-level buck converter 200 can have four states, i.e., state 5, state 6, state 7, and state 8. In state 5, between the time point t5 and the time point t6, the first switching device 210 and the second switching device 220 are in the off state, while the third switching device 230 and the fourth switching device 240 are in the on state. The inductor current i_L increases linearly. The phase node voltage Vph equals to the input voltage Vin. That is, Vph=Vin.

In state 6, between the time point t6 and the time point t7, the first switching device 210 and the third switching device 230 are in the off state, while the second switching device 220 and the fourth switching device 240 are in the on state. The inductor current i_L decreases linearly. The phase node voltage Vph equals to half of the input voltage Vin and can be represented by the above equation (1).

In state 7, between the time point t7 and the time point t8, the first switching device 210 and the second switching device 220 are in the off state, while the third switching device 230 and the fourth switching device 240 are in the on state. The inductor current i_L increases linearly. The phase node voltage Vph equals to the input voltage Vin and can be represented by the above equation (2).

In state 8, between the time point t8 and the time point t9, the first switching device 210 and the third switching device 230 are in the on state, while the second switching device 220 and the fourth switching device 240 are in the off state. The inductor current i_L decreases linearly. The phase node voltage Vph equals to half of the input voltage Vin and can be represented by the above equation (1).

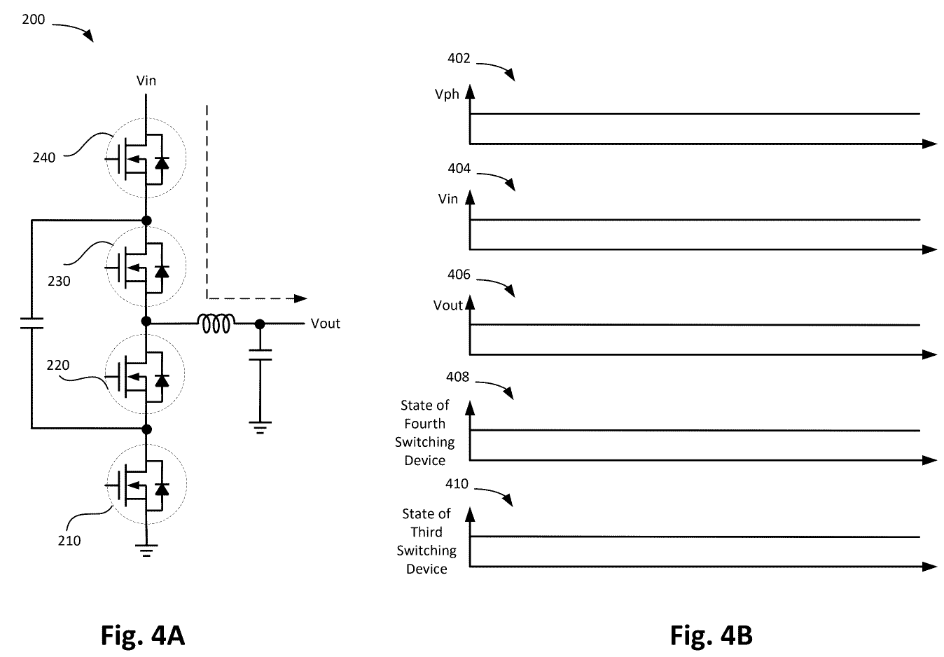

FIG. 4A is a diagram showing the example three-level buck converter 200 working in PTM according to an illustrative embodiment. FIG. 4B shows timing diagrams of the three-level buck converter 200 working in PTM according to an illustrative embodiment.

As described above, when the input voltage Vin drops below the configurable input voltage digitally configurable reference VinDAC, the three-level buck converter 200 can enter the PTM, allowing input voltage Vin to pass directly to the output. Referring to FIG. 4A, when the PTM is activated, the third switching device 230 and the fourth switching device 240 are in the on state, while the first switching device 210 and the second switching device 220 are in the off state. During the PTM, switching losses of the three-level buck converter 200 can be reduced as the third switching device 230 and the fourth switching device 240 remain on, creating a low-resistance path and effectively shorting the input to the output.

Referring to FIG. 4B, diagram 402 shows the phase node voltage Vph over time, wherein the vertical axis represents the phase node voltage Vph, and the horizontal axis represents time. Diagram 404 shows the input voltage Vin over time, wherein the vertical axis represents the input voltage Vin, and the horizontal axis represents time. Diagram 406 shows the converter output voltage Vout over time, wherein the vertical axis represents the converter output voltage Vout, and the horizontal axis represents time. Diagram 408 shows the on/off state of the fourth switching device 240 over time. Diagram 410 shows the on/off state of the third switching device 230 over time.

During the PTM, the third switching device 230 and the fourth switching device 240 remain in the on state, while the first switching device 210 and the second switching device 220 remain in the off state. In other words, there is no switching on the first switching device 210, the second switching device 220, the third switching device 230, and the fourth switching device 240. Meanwhile, the phase node voltage Vph remains the same, that is, equals to the input voltage Vin. At the same time, the converter output voltage Vout remains the same, that is, equals to the input voltage Vin. That is, Vout=Vin.

By shorting the input voltage Vin to the converter output voltage Vout through the third switching device 230 and the fourth switching device 240 of the three-level buck converter 200, the PTM of the three-level buck converter 200 can reduce switching losses and improve the efficiency. The PTM is advantageous in low input voltage scenarios, such as when a 5V USB input is used, as the PTM can reduce inductor losses and switching losses.

FIG. 5 is a diagram showing an example PDC 112 for implementing automatic PTM entry and exit based on an input voltage digitally configurable reference VinDAC according to an illustrative embodiment. PDC 112 can be used in the first stage controller 110 shown in FIG. 1

In the PDC 112, a configurable control bit Ctrl x[x] can be used to control the automatic PTM activation based on VinDAC without impacting other control loops in the system, such as the Vin loop, the CV loop, the CC loop, and the CL loop. The control bit Ctrl x[x] can be set to 0 or 1 by a user. Table 1 shows the functionality of the control bit Ctrl x[x]. For instance, when the control bit Ctrl x[x] is invalid (e.g., 0), the PDC 112 can select among four loops, i.e., Vin loop, CV loop, CC loop, and CL loop. Meanwhile, the input voltage digitally configurable reference VinDAC is used as a Vin loop reference.

Moreover, when the control bit Ctrl x[x] is valid (e.g., 1), the PDC 112 can select among three loops, i.e., CV loop, CC loop, and CL loop. Meanwhile, the input voltage digitally configurable reference VinDAC is used as the PTM entry threshold.

TABLE 1

| Ctrl x[x] | Ctrl Loop | VinDAC Usage |
|---|---|---|
| 0 | 4 loops (Vin loop, CV loop, | Vin Loop Reference |
| | CC loop, and CL loop) | |
| 1 | 3 loops (CV loop, CC loop, | PTM Entry Threshold |
| | and CL loop) | |

Referring to FIG. 5, the PDC 112 can include a first comparator 502, a second comparator 504, a third comparator 506, a fourth comparator 508, a fifth comparator 510, a loop selector 512, a Vin loop error amplifier 514, a CV loop error amplifier 516, an AC loop error amplifier 518, and a CC loop error amplifier 520, a PTM enable component 522, a first switch S1, a second switch S2, a third switch S3, a fourth switch S4, a first AND gate 524, a NOT gate 526, a second AND gate 528, a modulator & Driver 530, and an external pin 532.

In some implementations, components including the third comparator 506, fourth comparator 508, fifth comparator 510, loop selector 512, Vin loop error amplifier 514, CV loop error amplifier 516, AC loop error amplifier 518, CC loop error amplifier 520, PTM enable component 522, and switches S1, S2, S3, and S4 can collectively form a loop control mechanism 500. The mechanism 500 is configured to manage the switching between various control loops of the power conversion circuit, achieving control and regulation across different operating conditions.

The first comparator 502 receives input voltage digitally configurable reference VinDAC and the input voltage Vin as inputs. The output of the first comparator 502 is connected to one input of the first AND gate 524. The first comparator 502 can generate a comparison result signal 534 and feed the comparison result signal 534 to the other input of the first AND gate 524. For instance, when the input voltage Vin is below the input voltage digitally configurable reference VinDAC, the first comparator 502 can output a comparison result signal 534 at a high level (e.g., “1”).

The first AND gate receives comparison result signal 534 and the control bit Ctrl x[x] as inputs. The first AND gate can perform AND operation on the comparison result signal 534 and the control bit Ctrl x[x] and generate an AND result signal 536, which is fed to the PTM enable component 522. For instance, when both the comparison result signal 534 and the control bit Ctrl x[x] are high levels (e.g., “1”), the first AND gate can output the AND result signal 536 at a high level (e.g., “1”) to trigger the PTM enable component 522.

The PTM enable component 522 is configured to generate a PTM control signal 538 based on the AND result signal 536. The PTM control signal 538 is fed to the external pin 532. In some instances, the PTM control signal 538 can indicate the entry of the PTM of the power conversion circuit. In some other instances, the PTM control signal 538 can indicate the exit of the PTM of the power conversion circuit. For instance, when the AND result signal 536 is at a high level (e.g., “1”), the PTM enable component 522 can output PTM control signal 538 can indicate the entry of the PTM of the power conversion circuit. As another instance, when the AND result signal 536 is at a low level (e.g., “0”), the PTM enable component 522 can output the PTM control signal 538 can indicate the exit of the PTM of the power conversion circuit.

The second comparator 504 receives input voltage digitally configurable reference VinDAC and the input voltage Vin as inputs. The output of the second comparator 504 is connected to the loop selector 512 and the Vin loop error amplifier 514. The second comparator 504 can generate an input voltage loop error signal VL based on the inputs and feed the input voltage loop error signal VL to the loop selector 512 and the Vin loop error amplifier 514.

The third comparator 506 receives the system output voltage reference V_SYSDAC and the system output signal Vsys as inputs. The output of the third comparator 506 is connected to the loop selector 512 and the CV loop error amplifier 516. The third comparator 506 can generate a constant voltage error signal CV based on the inputs and feed the constant voltage error signal CV to the loop selector 512 and the CV loop error amplifier 516.

The fourth comparator 508 receives the adaptor current reference ACDAC and the adaptor current feedback signal ACFB as inputs. The output of the fourth comparator 508 is connected to the loop selector 512 and the AC loop error amplifier 518. The fourth comparator 508 can generate the adaptor current error signal AC and feed the adaptor current error signal AC to the loop selector 512 and the AC loop error amplifier 518. The adapter current limit (AC) loop is equal to the CL (output current limit) loop.

The fifth comparator 510 receives the charging current reference CCDAC and a charging current feedback signal CCFB as inputs. The output of the fifth comparator 510 is connected to the loop selector 512 and CC loop error amplifier 520. The fifth comparator 510 can generate a charging current error signal CC and feed the charging current error signal CC to the loop selector 512 and the CC loop error amplifier 520.

The loop selector 512 receives the input voltage loop error signal VL from the second comparator 504, the constant voltage loop error signal CV from the third comparator 506, the average current loop error signal AC from the fourth comparator 508, and the charging current loop error signal CC from the fifth comparator 510.

A first output of the loop selector 512 is connected to one input of the second AND gate 528. The other input of the second AND gate 528 is connected to the control bit Ctrl x[x] via the NOT gate 526. The output of the second AND gate is connected to the first switch S1. For instance, when the control bit Ctrl x[x] is invalid (e.g., “0”), and the first output of the loop selector 512 is at a high level (e.g., “1”), the output of the second AND gate 528 is at a high level, S1 is closed such that the signal generated by the Vin loop error amplifier 514 is fed to the modulator & driver 530.

A second output of the loop selector 512 can be connected to the second switch S2, the third switch S3, and the fourth switch S4. The loop selector 512 can dynamically select feedback control loops based on load and input voltage conditions. The loop selector 512 can also control the operations of the first switch S1, the second switch S2, the third switch S3, and the fourth switch S4. For instance, the loop selector 512 can output a signal to close the second switch S2 such that the signal output by the CV loop error amplifier 516 is fed to the modulator & driver 530.

The Vin loop error amplifier 514 is configured to activate the input voltage loop of the power conversion circuit. The Vin loop error amplifier 514 receives the input voltage loop error signal VL from the second comparator 504. The output of the Vin loop error amplifier 514 is connected to the modulator& driver 530 via the first switch S1.

The CV loop error amplifier 516 is configured to activate the CV loop of the power conversion circuit. The CV loop error amplifier 516 receives the constant voltage error signal CV from the third comparator 506. The output of the CV loop error amplifier 516 is connected to the modulator & driver 530 via the second switch S2.

The AC loop error amplifier 518 is configured to activate the AC loop of the power conversion circuit. The AC loop error amplifier 518 receives the adaptor current error signal AC from the third comparator 506. The output of the AC loop error amplifier 518 is connected to the modulator & driver 530 via the third switch S3.

The CC loop error amplifier 520 is configured to activate the CC loop of the power conversion circuit. The CC loop error amplifier 520 receives the charging current error signal CC from the third comparator 506. The output of the CC loop error amplifier 520 is connected to the modulator & driver 530 via the fourth switch S4.

During operation, a respective feedback signal (e.g., Vin, Vsys, ACFB, and CCFB) is compared with a respective reference (e.g., VinDAC, V_SYSDAC, ACDAC, and CCDAC). If the feedback signal deviates from the reference, an error signal is generated and amplified by the respective error amplifier (e.g., the Vin loop error amplifier 514, the CV loop error amplifier 516, the AC loop error amplifier 518, and the CC loop error amplifier 520). The amplified error signal is fed to the modulator & driver 530 for driving the power conversion circuit.

The modulator & driver 530 is configured to modulate and drive the power conversion circuit to operate in the respective loop (e.g., Vin loop, the CV loop, the AC loop, and the CC loop). For instance, the power conversion circuit is the three-level buck converter 200 shown in FIG. 2.

In implementations, the PDC 112 can maintain proper performance under different load and input conditions. The PDC 112 uses the input voltage digitally configurable reference VinDAC as a PTM threshold, and the configurable control bit Ctrl x[x] to enable the automatic entry and exit of PTM. When the control bit Ctrl x[x] is invalid (e.g., the control bit Ctrl x[x] is 0), the PDC 112 can select among four loops i.e., the Vin loop, the CV loop, the AC loop, and the CC loop. Under such circumstances, VinDAC is used as the Vin loop reference.

When the control bit Ctrl x[x] is valid (e.g., the control bit Ctrl x[x] is 1), the PDC 112 can select among three loops i.e., the CV loop, the AC loop, and the CC loop. Meanwhile, the input voltage digitally configurable reference VinDAC is used as the PTM threshold. Meanwhile, when the input voltage Vin falls below the PTM threshold, the PTM enable component 522 generates a PTM control signal 538 to activate the PTM of the power conversion circuit. Other the other hand, when the input voltage goes above the PTM threshold, the PTM enable component 522 generates a PTM control signal 538 to exit the PTM of the power conversion circuit. Such a scheme improves flexibility and allows for efficient control in high-power applications, particularly in USB PD scenarios where voltage and power levels fluctuate dynamically.

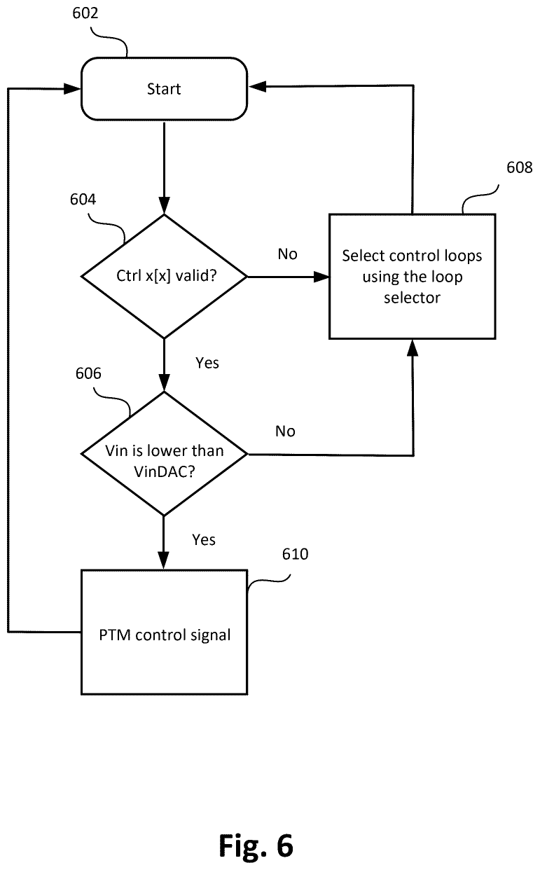

FIG. 6 illustrates a process 600 that implements automatic PTM entry and exit based on an input voltage digitally configurable reference VinDAC according to an illustrative embodiment. In this example, the input voltage digitally configurable reference VinDAC is used as the PTM entry threshold and is configurable. The process 600 can be implemented by the system 100 shown in FIG. 1. More particularly, the process 600 can be implemented by the PDC 112 shown in FIG. 5. Process 600 can include one or more operations, actions, or functions as illustrated by one or more of blocks 602-610. Although illustrated as discrete blocks, various blocks may be divided into additional blocks, combined into fewer blocks, eliminated, performed in different order, or performed in parallel, depending on the desired implementation.

Process 600 can start at block 602. Process 600 can proceed from block 602 to block 604. At block 604, the PDC 112 can determine whether the control bit Ctrl x[x] is valid. If the control bit Ctrl x[x] is valid, process 600 can proceed from block 604 to block 606. If the control bit Ctrl x[x] is not valid, process 600 can proceed from block 604 to block 608.

At block 606, the PDC 112 can determine whether the input voltage Vin is lower than the input voltage digitally configurable reference VinDAC. If the input voltage Vin is lower than the input voltage digitally configurable reference VinDAC, process 600 can proceed from block 606 to block 610. If the input voltage Vin is equal to or high than the input voltage digitally configurable reference VinDAC, process 600 can proceed from block 606 to block 608.

At block 608, the PDC 112 can select, using the loop selector 512, the control loops, i.e., the Vin loop, the CV loop, the CC loop, and the CL loop.

At block 610, the PDC 112 can generate a PTM control signal 538 to activate PTM of the power conversion circuit. In this example, the power conversion circuit is the three-level buck converter 200 shown in FIG. 2.

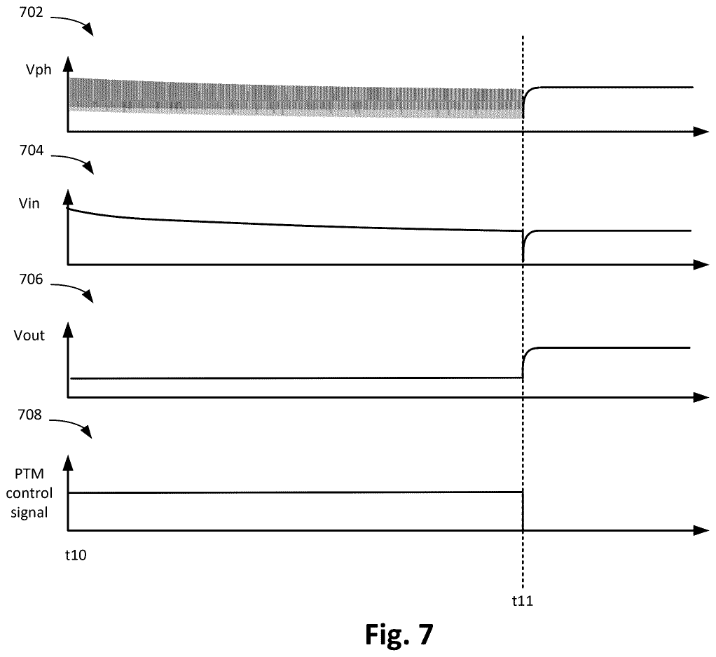

FIG. 7 shows example simulation results of the system 100 for implementing automatic PTM entry and exit based on an input voltage digitally configurable reference VinDAC according to an illustrative embodiment. In this example, the test conditions can be as follows. The input voltage Vin decreases from 8 Volt (V) to 5 V. The output voltage reference VsysDAC is 3.8 V. The input voltage digitally configurable reference is 5.3 V.

Diagram 702 shows the phase node voltage Vph over time, wherein the vertical axis represents the phase node voltage Vph, and the horizontal axis represents time. Diagram 704 shows the input voltage Vin over time. Diagram 706 shows the converter output voltage Vout over time. Diagram 708 shows the state of the PTM control signal over time.

Referring to FIG. 7, between the time point t10 and the time point t11, the phase node voltage Vph changes at a high frequency because of the switching activities of the switching devices (e.g., the first switching device 210, the second switching device 220, the third switching device 230, and the fourth switching device 240) in the three-level buck converter 200. During the period between the time point t10 and the time point t11, the input voltage Vin decreases gradually, while the converter output voltage Vout remains the same (3.8V in this example). Meanwhile, the PTM control signal 538 is at a high level, indicating that the PTM is not activated in this example.

At the time point t11, the input voltage Vin falls below the PTM threshold i.e., VinDAC (5.3V in this example). Accordingly, the PTM control signal 538 changes from the high level to a low level, indicating the PTM entry of the three-level buck converter 200. Accordingly, the phase node voltage Vph stops changing, and remains the same after the time point t11. That is, phase node voltage Vph equals to the input voltage Vin after entering the PTM. At the same time, the converter output voltage Vout transits from a low level (3.8V in this example) to a high level (5V in this example) at the time point t11 and remains at the high level after the time point t11.

### EXAMPLES

Example 1: A system for implementing pass-through mode (PTM) of a power conversion circuit, the system comprising: a first stage controller; and a first stage connected to the first stage controller, wherein: the first stage controller is configured to monitor an input voltage and generate a PTM control signal based on the input voltage to control an operation of the first stage; and the first stage comprises the power conversion circuit configured to convert the input voltage to a converter output voltage.

Example 2: The system of Example 1, wherein the power conversion circuit comprises: a first switching device; a second switching device; a third switching device; a fourth switching device; a flying capacitor; an inductor; and an output capacitor, wherein: the first switching device and the second switching device are connected in series between a ground and the inductor; the first switching device and the second switching device are connected at a first node; the third switching device and the fourth switching device are connected in series between the inductor and the input voltage; the third switching device and the fourth switching device are connected at a second node; the second switching device and the third switching device are connected at a phase node; the flying capacitor is connected between the first node and the second node; the inductor is connected between the phase node and the converter output voltage; and the output capacitor is connected between the ground and the converter output voltage.

Example 3: The system of any one of Examples 1 and 2, wherein the first switching device and the second switching device are in an off state, and the third switching device and the fourth switching device are in an on state when the PTM of the power conversion circuit is entered.

Example 4: The system of any one of Examples 1 to 3, wherein the first stage controller comprises a power delivery controller (PDC) configured to: receive a control bit; determine whether the control bit is valid; determine whether the input voltage is lower than an input voltage digitally configurable reference upon determining that the control bit is valid; and provide the PTM control signal indicating entry of the PTM of the power conversion circuit upon determining that the input voltage is lower than the input voltage digitally configurable reference.

Example 5: The system of any one of Examples 1 to 4, wherein the PDC is further configured to provide the PTM control signal indicating exit of the PTM upon determining that the input voltage is equal to or greater than the input voltage digitally configurable reference.

Example 6: The system of any one of Examples 1 to 5, wherein the control bit is configurable.

Example 7: The system of any one of Examples 1 to 6, wherein the input voltage digitally configurable reference is configurable.

Example 8: The system of any one of Examples 1 to 7, further comprising a second stage connected to the first stage, the second stage being configured to receive the converter output voltage from the first stage and provide a system output voltage based on the converter output voltage.

Example 9: An integrated circuit for implementing pass-through mode (PTM) of a power conversion circuit, the integrated circuit comprising: a first stage controller configured to monitor an input voltage; and a first stage connected to the first stage controller, the first stage comprising the power conversion circuit configured to step down the input voltage to a converter output voltage, wherein the first stage controller is further configured to generate a PTM control signal to activate the PTM of the power conversion circuit upon determining that the input voltage is lower than an input voltage digitally configurable reference.

Example 10: The integrated circuit of Example 9, wherein the power conversion circuit comprises: a first switching device; a second switching device; a third switching device; a fourth switching device; a flying capacitor; an inductor; and an output capacitor, wherein: the first switching device and the second switching device are connected in series between a ground and the inductor; the first switching device and the second switching device are connected at a first node; the third switching device and the fourth switching device are connected in series between the inductor and the input voltage; the third switching device and the fourth switching device are connected at a second node; the second switching device and the third switching device are connected at a phase node; the flying capacitor is connected between the first node and the second node; the inductor is connected between the phase node and the converter output voltage; and the output capacitor is connected between the ground and the converter output voltage.

Example 11: The integrated circuit of any one of Examples 9 and 10, wherein the first switching device and the second switching device are in an off state, and the third switching device and the fourth switching device are in an on state when the PTM of the power conversion circuit is activated.

Example 12: The integrated circuit of any one of Examples 9 to 11, wherein the first stage controller comprises a power delivery controller (PDC) configured to: receive a control bit; determine whether the control bit is valid; determine whether the input voltage is lower than the input voltage digitally configurable reference upon determining that the control bit is valid; and provide a PTM control signal indicating entry of the PTM of the power conversion circuit upon determining that the input voltage is lower than the input voltage digitally configurable reference.

Example 13: The integrated circuit of any one of Examples 9 to 12, wherein the PDC is further configured to provide the PTM control signal indicating exit of the PTM upon determining that the input voltage is equal to or greater than the input voltage digitally configurable reference.

Example 14: The integrated circuit of any one of Examples 9 to 13, wherein the control bit is configurable.

Example 15: The integrated circuit of any one of Examples 9 to 14, wherein the input voltage digitally configurable reference is configurable.

Example 16: A method for implementing pass-through mode (PTM) of a power conversion circuit, the method comprising: receiving a control bit; determining whether the control bit is valid; determining whether an input voltage is lower than an input voltage digitally configurable reference upon determining that the control bit is valid; and providing a PTM control signal indicating entry of the PTM of the power conversion circuit upon determining that the input voltage is lower than the input voltage digitally configurable reference.

Example 17: The method of Example 16, further comprising proving the PTM control signal indicating exit of the PTM upon determining that the input voltage is equal to or greater than the input voltage digitally configurable reference.

Example 18: The method of any one of Examples 16 and 17, wherein the control bit is configurable.

Example 19: The method of any one of Examples 16 to 18, wherein the input voltage digitally configurable reference is configurable.

Example 20: The method of any one of Examples 16 to 19, wherein the power conversion circuit comprises a three-level buck converter.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting to the present disclosure. As used herein, the singular forms “a”, “an” and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present disclosure have been presented for purposes of illustration and description but are not intended to be exhaustive or limited to the embodiments in the forms disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

What is claimed is:

1. A system for implementing pass-through mode (PTM) of a power conversion circuit, the system comprising:
a first stage controller; and
a first stage connected to the first stage controller,
wherein:
the first stage controller is configured to monitor an input voltage and generate a PTM control signal based on the input voltage to control an operation of the first stage; and
the first stage comprises the power conversion circuit configured to convert the input voltage to a converter output voltage.

2. The system of claim 1, wherein the power conversion circuit comprises:
a first switching device;
a second switching device;
a third switching device;
a fourth switching device;
a flying capacitor;
an inductor; and
an output capacitor,
wherein:
the first switching device and the second switching device are connected in series between a ground and the inductor;
the first switching device and the second switching device are connected at a first node;
the third switching device and the fourth switching device are connected in series between the inductor and the input voltage;
the third switching device and the fourth switching device are connected at a second node;
the second switching device and the third switching device are connected at a phase node;
the flying capacitor is connected between the first node and the second node;
the inductor is connected between the phase node and the converter output voltage; and
the output capacitor is connected between the ground and the converter output voltage.

3. The system of claim 2, wherein the first switching device and the second switching device are in an off state, and the third switching device and the fourth switching device are in an on state when the PTM of the power conversion circuit is entered.

4. The system of claim 1, wherein the first stage controller comprises a power delivery controller (PDC) configured to:
receive a control bit;
determine whether the control bit is valid;
determine whether the input voltage is lower than an input voltage digitally configurable reference upon determining that the control bit is valid; and
provide the PTM control signal indicating entry of the PTM of the power conversion circuit upon determining that the input voltage is lower than the input voltage digitally configurable reference.

5. The system of claim 4, wherein the PDC is further configured to provide the PTM control signal indicating exit of the PTM upon determining that the input voltage is equal to or greater than the input voltage digitally configurable reference.

6. The system of claim 4, wherein the control bit is configurable.

7. The system of claim 4, wherein the input voltage digitally configurable reference is configurable.

8. The system of claim 1, further comprising a second stage connected to the first stage, the second stage being configured to receive the converter output voltage from the first stage and provide a system output voltage based on the converter output voltage.

9. An integrated circuit for implementing pass-through mode (PTM) of a power conversion circuit, the integrated circuit comprising:
a first stage controller configured to monitor an input voltage; and
a first stage connected to the first stage controller, the first stage comprising the power conversion circuit configured to step down the input voltage to a converter output voltage, wherein the first stage controller is further configured to generate a PTM control signal to activate the PTM of the power conversion circuit upon determining that the input voltage is lower than an input voltage digitally configurable reference.

10. The integrated circuit of claim 9, wherein the power conversion circuit comprises:
a first switching device;
a second switching device;
a third switching device;
a fourth switching device;
a flying capacitor;
an inductor; and
an output capacitor,
wherein:
the first switching device and the second switching device are connected in series between a ground and the inductor;
the first switching device and the second switching device are connected at a first node;
the third switching device and the fourth switching device are connected in series between the inductor and the input voltage;
the third switching device and the fourth switching device are connected at a second node;
the second switching device and the third switching device are connected at a phase node;
the flying capacitor is connected between the first node and the second node;
the inductor is connected between the phase node and the converter output voltage; and
the output capacitor is connected between the ground and the converter output voltage.

11. The integrated circuit of claim 10, wherein the first switching device and the second switching device are in an off state, and the third switching device and the fourth switching device are in an on state when the PTM of the power conversion circuit is activated.

12. The integrated circuit of claim 9, wherein the first stage controller comprises a power delivery controller (PDC) configured to:
receive a control bit;
determine whether the control bit is valid;
determine whether the input voltage is lower than the input voltage digitally configurable reference upon determining that the control bit is valid; and
provide a PTM control signal indicating entry of the PTM of the power conversion circuit upon determining that the input voltage is lower than the input voltage digitally configurable reference.

13. The integrated circuit of claim 12, wherein the PDC is further configured to provide the PTM control signal indicating exit of the PTM upon determining that the input voltage is equal to or greater than the input voltage digitally configurable reference.

14. The integrated circuit of claim 12, wherein the control bit is configurable.

15. The integrated circuit of claim 12, wherein the input voltage digitally configurable reference is configurable.

16. A method for implementing pass-through mode (PTM) of a power conversion circuit, the method comprising:
receiving a control bit;
determining whether the control bit is valid;
determining whether an input voltage is lower than an input voltage digitally configurable reference upon determining that the control bit is valid; and
providing a PTM control signal indicating entry of the PTM of the power conversion circuit upon determining that the input voltage is lower than the input voltage digitally configurable reference.

17. The method of claim 16, further comprising proving the PTM control signal indicating exit of the PTM upon determining that the input voltage is equal to or greater than the input voltage digitally configurable reference.

18. The method of claim 16, wherein the control bit is configurable.

19. The method of claim 16, wherein the input voltage digitally configurable reference is configurable.

20. The method of claim 16, wherein the power conversion circuit comprises a three-level buck converter.
